(19) United States
(12) Patent Application Publication
(10) Pub. No.: US 2008/0298943 A1
(43) Pub. Date: Dec. 4, 2008

(54) Postal-Go-Round

(76) Inventors: Cynthia L. Siegel, Pleasant Hill, CA (US); Cristino E. Alegria, Vallejo, CA (US)

Correspondence Address: FLIESLER MEYER LLP, 650 CALIFORNIA STREET, 14TH FLOOR, SAN FRANCISCO, CA, 94108, US

(21) Appl. No.: 11/863,112

(22) Filed: Sep. 27, 2007

Related U.S. Application Data
(60) Provisional application No. 60/932,606, filed on Jun. 1, 2007.

(51) Int. Cl. B65G 47/00

(52) U.S. Cl. 414/567

(57) ABSTRACT

An apparatus is provided for assisting a user in loading and unloading storage bins and goods to and from the back of a vehicle. The apparatus includes two chain drive supports that are elliptical in shape and positioned vertically and parallel to each other. Two chain drives rotate around sprocket guides attached to the two chain drive supports. Multiple bin carriers are attached on two sides to the two chain drives, and each bin carrier is capable of receiving a storage bin. A support stand that supports the chain drive supports attaches to the vehicle floor via floor mounts. A motor is attached to the support stand and drives a plurality of parallel chain drives, which in turn drive the two chain drives in unison to cause the bin carriers to rotate around each other in an ellipsis.

### CLAIM OF PRIORITY

The present application claims priority to U.S. Provisional Patent Application No. 60/932,606, entitled “LOADING AND UNLOADING SYSTEM FOR TRUCKS AND VANS” by Cynthia L. Siegel, filed Jun. 26, 2007, which is incorporated by reference herein in its entirety.

### BACKGROUND

1. Field of the Invention

The present invention is related to a mechanized apparatus for loading and unloading goods into vans and trucks.

2. Description of the Related Art

Vans and trucks are often used for the transport of goods that need to be loaded and unloaded from the back of those vehicles. In smaller vans and trucks, versus large transport vehicles, the loading and unloading is accomplished manually. Goods of varying shapes, sizes, and weights can make loading and unloading of these goods difficult to organize and physically demanding. Manual loading can result in problematic access to the goods and inefficient use of the carrying capacity of the vehicle. Additionally, manual loading places physical strain on the person doing the loading and unloading. Goods not carefully organized in loading to prevent damage might not arrive in excellent condition at the delivery site as a result. Finally, manual loading and unloading is typically a slow procedure because goods need to be manually moved within the vehicle to allow access to other goods contained in the van or truck.

It would be beneficial to assist people in loading and unloading storage bins, particularly into and out of the back of a van or a truck.

### BRIEF SUMMARY

A mechanized apparatus is provided for assisting a user in loading and unloading goods in and out of the back of a van or a truck. The apparatus includes left and right chain drives that are positioned vertically and parallel to each other. The chain drives are elliptical in shape. A motor attached to the apparatus drives parallel chain drives, which in turn drive the left and right chain drives. Two or more bin carriers are each attached to both the left and right chain drives. Goods can be loaded into a storage bin, which is loaded into a bin carrier, or goods can be directly loaded into the bin carrier. The apparatus is lightweight, yet strong to support the chain drives and goods.

The bin carriers rotate as left and right chain drives rotate in unison. The bin carriers can rotate clockwise or counterclockwise. The mechanized rotation of the bin carriers reduces the physical demands of the person doing the loading and unloading and greatly improves the efficiency of that process. Because people are of varying heights, the rotating bin carriers can be stopped at any convenient height for easy loading and unloading. A user can also move the bin carriers or storage bins to rotate the bin carriers manually.

The apparatus is portable and can be used in any indoor or outdoor location, as well as in multiple types of vehicles. The apparatus is also customizable to any size and to fit spaces of various sizes and dimensions. The apparatus is further customizable to attach to walls or to floors of a vehicle interior. Two of the apparatuses can be located side by side in a vehicle.

### BRIEF DESCRIPTION OF THE DRAWINGS

Further details of the present invention are explained with the help of the attached drawings in which:

FIG. 1 is a right perspective view showing a Postal-Go-Round having bin carriers, according to embodiments of the present invention;

FIG. 2 is a left perspective view showing the Postal-Go-Round of FIG. 1, according to embodiments of the present invention;

FIG. 3 shows two example bin carriers loaded with storage bins, according to embodiments of the present invention;

FIG. 4 is a right perspective view showing an alternative embodiment of the Postal-Go-Round, according to embodiments of the present invention; and

FIG. 5 shows an alternative example bin carrier, according to embodiments of the present invention.

### DETAILED DESCRIPTION

The present invention provides mechanized system for loading and unloading goods into and out of the back of a van or truck. The goods can be letters and packages of differing shapes, sizes, and weights. The mechanized means by which goods can be loaded reduces the physical demands of the person doing the loading and unloading and greatly improves the efficiency of that process.

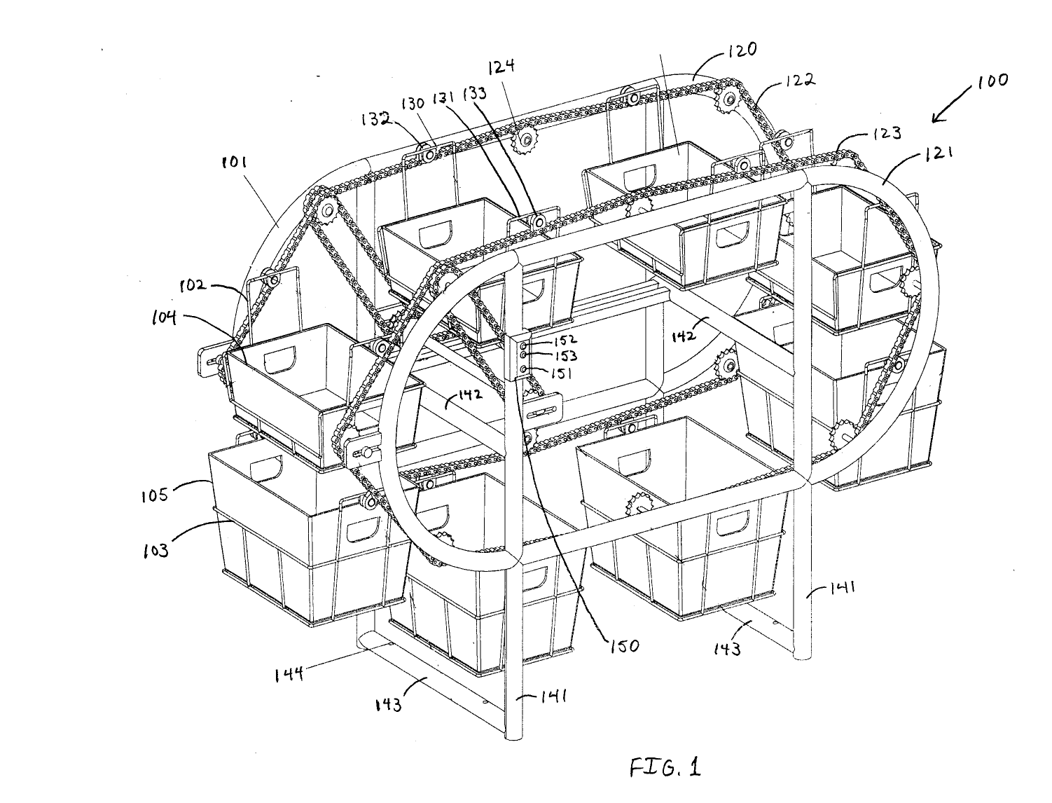

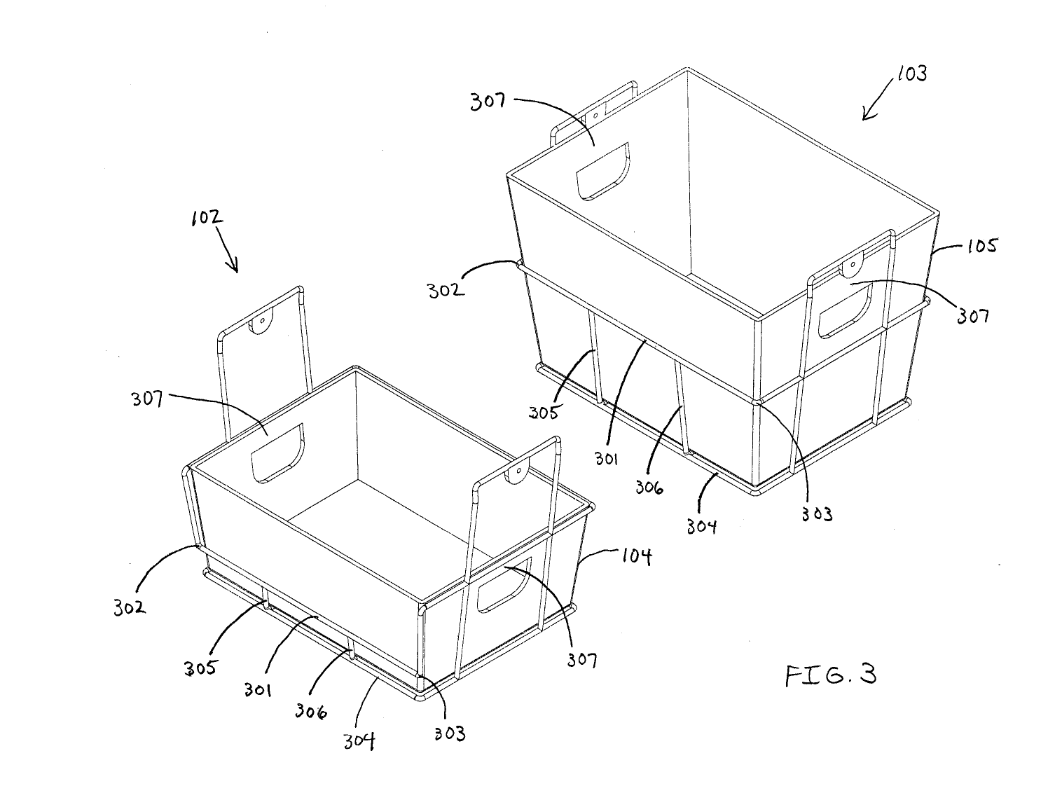

FIG. 1 is a right perspective view showing a Postal-Go-Round having bin carriers, according to embodiments of the present invention. The Postal-Go-Round 100 includes a support stand 101 or frame, and has eight bin carriers 102 and 103. In embodiments, the Postal-Go-Round can contain any number of bin carriers. Storage bins are loaded into the bin carriers, one bin per bin carrier. Alternatively, goods can be loaded directly into the bin carriers. The bin carriers can contain any size storage bin, but in the example of FIG. 1, bin carriers 102 can contain smaller size storage bins 104, and bin carriers 103 can contain full size storage bins 105. Bins 104 and 105 are not part of the invention but are included in FIG. 1 for illustrative purposes to show the manner in which they are used with the invention. The design of the bin carriers is discussed in more detail below with respect to FIG. 3.

The Postal-Go-Round 100 can be used in a van or truck to carry and deliver goods. The Postal-Go-Round 100 can also be used in any location outdoors or indoors, or in other types of vehicles. For vans or trucks having an internal space of five feet high, six feet deep, and five feet wide, the dimensions of the Postal-Go-Round 100, including holders and support apparatus, are between four feet eight inches and just under five feet high, just under six feet deep, and two feet wide. In embodiments, the Postal-Go-Round 100 can be of any height, depth, and width. It is thus customizable to fit spaces of various sizes and dimensions. In embodiments, two or more Postal-Go-Rounds can be located side by side in a van or truck.

The support stand 101 includes a left chain drive support 120 and a right chain drive support 121. Both chain drive supports 120 and 121 are elliptical in shape, and in embodiments can both be other shapes as well. They are positioned vertically and are located parallel to each other. In a van or truck having the internal space dimensions described above, each chain drive support can have a length of five feet and a height of one foot ten inches. In embodiments, the chain drive supports can be of any length and height.

Around the left chain drive support 120 is a left chain drive 122, and around the right chain drive support 121 is a right chain drive 123. Each chain drive is located on the inside of the support stand 101 such that the chain drives face each other. Sprocket guides 122 are attached to each chain drive support 120 and 121 to guide the chain drives 122 and 123 attached to them. Any number of sprocket guides can be attached around the chain drive supports. In embodiments, belts, and roller guides can be used instead of chain drives and sprocket guides.

For each bin carrier 102, left and right bin carrier handles 130 and 131 of the bin carrier are mounted to left and right carrier mounts 132 and 133, respectively, which in turn are attached to left and right chain drives 122 and 123, respectively. The carrier mounts 132 and 133 can be, but do not necessarily need to be, attached to the chain drives 132 and 133 at evenly spaced points around the chain drives.

Providing structural support and housing for the chain drive supports 120 and 121 in the support stand 101 are vertical supports 141, lateral supports 142, and floor mounts 143. In embodiments, two vertical supports 141 support each chain drive support 120 and 121 and are welded to each chain drive support. In embodiments, two lateral supports 142 and two floor mounts 143 provide lateral support for the support stand 101 and are welded to vertical supports 141. The support stand 101 can be mounted to a floor with screws through the mount holes 144 of the floor mounts 143. Depending on the location of the Postal-Go-Round 100, the floor can be outdoors on the ground, the floor inside a building, or the floor inside a vehicle.

Postal-Go-Round 100 is mechanized to rotate the chain drives 122 and 123 in unison. The user of the Postal-Go-Round can control the rotation of the belts by using a switch located on a vertical support 150. The switch includes an on/off button 151, as well as forward and reverse buttons 152 and 153, respectively, to rotate the chain drives in either a clockwise or a counterclockwise direction. The rotation of the chain drives causes the bin carriers 102 to rotate around the rail guides in an ellipse. The bin carrier handles 130 and 131 can rotate around their respective carrier mounts 132 and 133. Thus, the bin carriers can remain vertical as they rotate. Alternatively, a user can move the bin carriers 102 or storage bins 103 and 104 to rotate the holders manually. In embodiments, the user can also rotate the holders manually by using a crank (not shown). Because people are of varying heights, the rotating bin carriers 102 can be stopped at any convenient height for easy loading and unloading.

If housed in a vehicle, Postal-Go-Round 100 can be connected to draw power from the vehicle's battery. If housed elsewhere, Postal-Go-Round 100 can be connected to run from a battery.

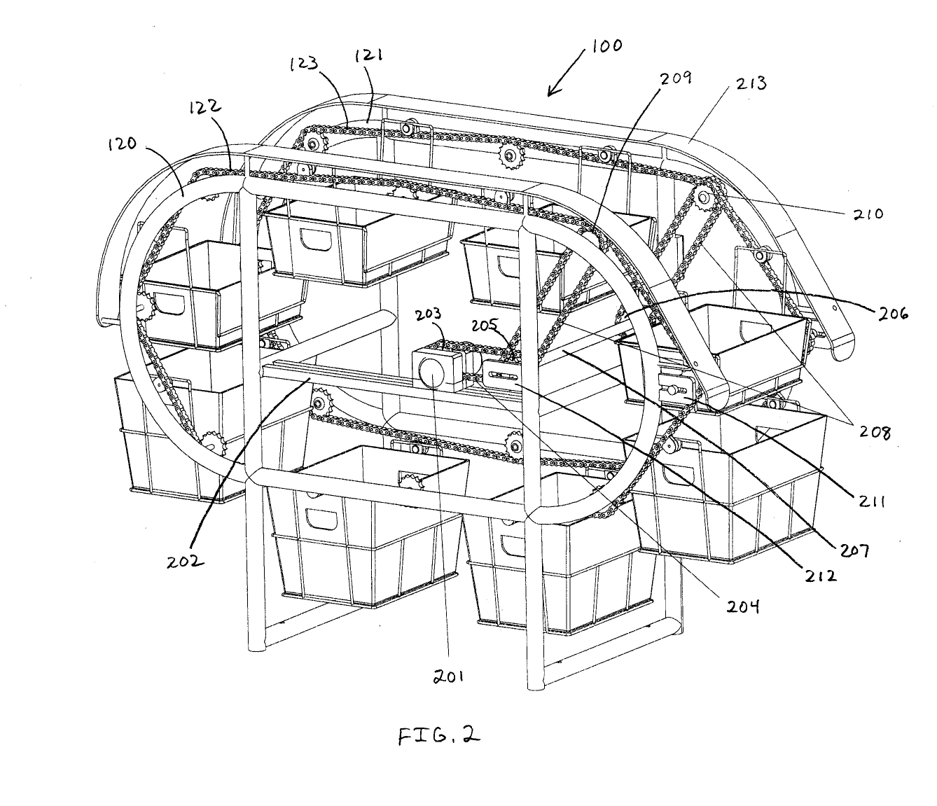

FIG. 2 is a left perspective view showing the Postal-Go-Round of FIG. 1, according to embodiments of the present invention. For convenience, components carried over from FIG. 1 to other figures are similarly labeled. FIG. 2 clearly shows the mechanized portion of the Postal-Go-Round. A twelve-volt motor 201 is attached to a horizontal motor drive support 202. The motor 201 drives motor sprocket guide 203 to rotate motor drive chain 204 around a first double sprocket assembly 205. The first double sprocket assembly 205 is also attached to a sprocket guide 206 via a horizontal shaft 207. The connection of the horizontal shaft 207 to the assembly 205 and sprocket guide 206 causes the sprocket guide 206 to rotate in unison with the assembly 205. Assembly 205 and sprocket guide 206 each rotate a parallel chain drive 208 around a second double sprocket assembly 209 and a third double sprocket assembly 210. The left and right chain drives 122 and 123, respectively, are also attached to the second and third double sprocket assemblies 209 and 210, respectively. Thus, the parallel chain drives 208 simultaneously drive the left and right chain drives 122 and 123.

The left and right chain drives 122 and 123 each have a chain drive tension adjustment mount 211 to adjust the tension in each of these chain drives separately. Similarly, the parallel chain drives each have a parallel chain tension adjustment mount 212 to adjust the tension in each of these chain drives separately. Optional chain guards 213 are attached to both chain drive supports 120 and 121 to protect the user from touching the chain drives 122 and 123. Alternatively, the chain guards 212 could guard the entirety of these chain drives.

FIG. 3 shows two example bin carriers loaded with storage bins, according to embodiments of the present invention. For either bin carrier 102 or 103, the user can load and unload the storage bin from the bin carrier by first opening the bin carrier. The user can pull the horizontal bar 301 downward, and the bar will unlatch from points 302 and 303. The horizontal bar 301 is attached to hinge 304 of the bin carrier via vertical bars 305 and 306. After a user places a storage bin into the bin carrier, the user then pushes the horizontal bar 301 upward to latch it to points 302 and 303. To remove a storage bin from the bin carrier, the user can grab the storage bin and pull it toward the user. The user can then pick up the storage bin by two bin handles 307, formed by the top of the bin and cutout areas near the top of the bin.

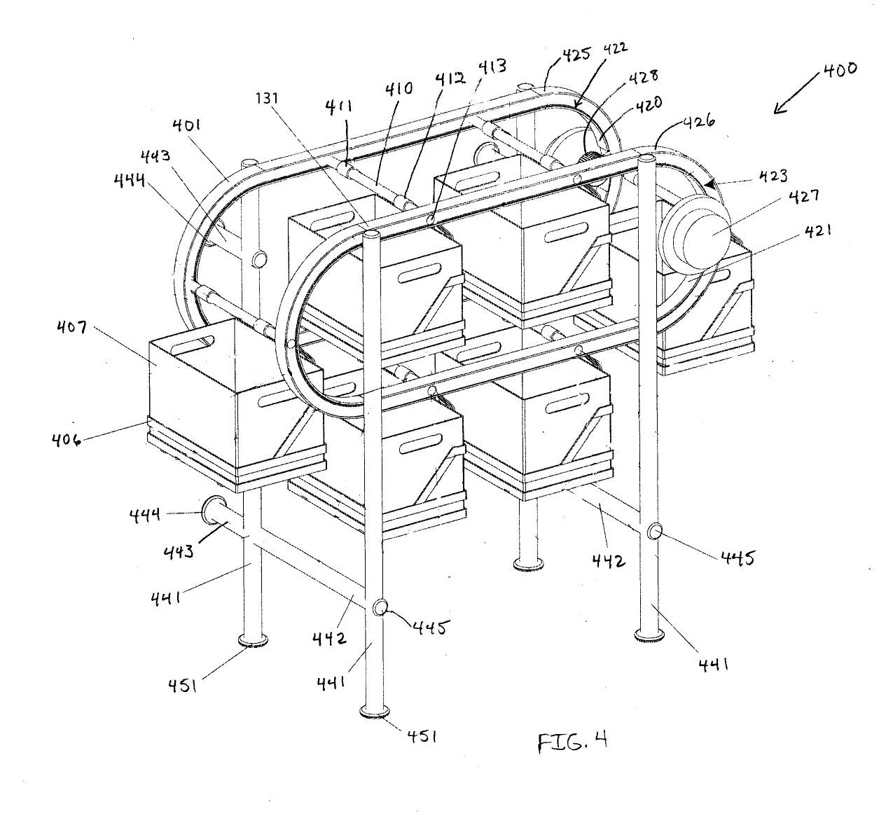

FIG. 4 is a right perspective view showing an alternative embodiment of the Postal-Go-Round, according to embodiments of the present invention. Some of the features described in the discussion for the FIG. 1 Postal-Go-Round embodiment are the same as those for the embodiment of FIG. 4. The focus of the following discussion is on the FIG. 4 features that are not shown in FIG. 1. The features of the embodiments in FIGS. 1 and 4 can be used in any combination.

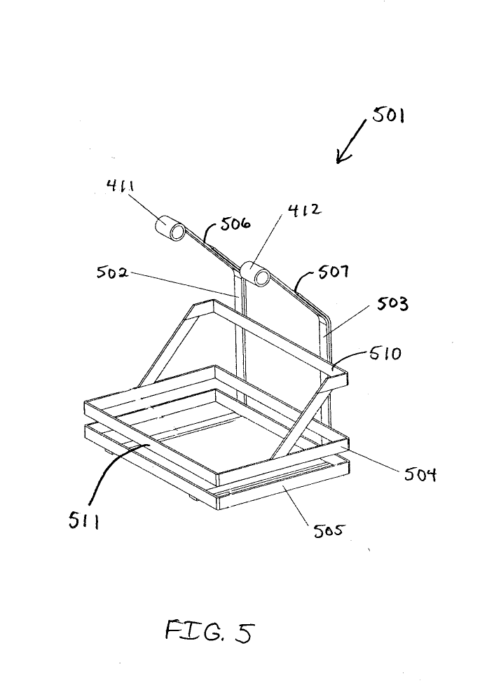

The Postal-Go-Round 400 includes a support stand 401, or frame, and has six bin carriers 406. In embodiments, the Postal-Go-Round 400 can contain any number of bin carriers. Storage bins 407 are loaded into the bin carriers, one bin per carrier. Alternatively, goods can be loaded directly into the bin carriers 406. Bin carriers 406 can contain any size storage bin 407. Storage bins 407 are not part of the invention but are included in FIG. 4 for illustrative purposes to show the manner in which they are used with the invention. Bin carriers 406 hang from bin support bars 410, and each bin carrier is attached to a bin support bar 410 at two carrier mounts 411 and 412. Optionally, each bin support bar 410 has bin support end caps 413 at each end. The design of the bin carriers is discussed in more detail below with respect to FIG. 5.

The support stand 401 has a left rail guide 420 and right rail guide 421. Each rail guide is elliptical in shape, and in embodiments can be other shapes as well. They are positioned vertically and are located parallel to each other. In a van or truck having the internal space dimensions described above, each rail guide can have a length of five feet and a height of one foot ten inches. In embodiments, the rail guides can be of any length and height.

Around the left rail guide 420 is a left belt 422, and around the right rail guide 421 is a right belt 423. In embodiments, chain drives can be used instead of belts. The ends of each bin support bar 410 are attached to the left belt 422 and right belt 423. The bin support bars 410 can be, but do not necessarily need to be, attached to the belts 422 and 423 at evenly spaced points around the belts. Encasing the belt are left and right rail side covers 425 and 426, respectively, to protect a user from touching the belts.

The Postal-Go-Round 400 is mechanized to rotate the belt in each of rail guides 420 and 421 in unison. Two twelve-volt motors 427 drive sprockets 428, which in turn drive the rotation of the belts 422 and 423. In embodiments, one motor can drive two connected sprockets to drive the rotation of the belts. The user of the Postal-Go-Round can control the rotation of the belts by using a switch. The belts can rotate in either a clockwise or a counterclockwise direction. The rotation of the belts causes the bin support bars 410 to rotate around the rail guides, and thus bin carriers 406 rotate around in an ellipse. The bin carriers 406 can rotate around their respective bin support bars 410, and thus the bin carriers can remain vertical as they rotate. Alternatively, a user can move the bin carriers, carrier mounts, or storage bins to rotate the bin carriers manually. In embodiments, the user can also move rotate the holders by using a crank (not shown). Because people are of varying heights, the rotating bin carriers 406 can be stopped at any convenient height for easy loading and unloading.

If housed in a vehicle, Postal-Go-Round 400 can be connected to draw power from the vehicle's battery. If housed elsewhere, Postal-Go-Round 400 can be plugged into an electrical outlet.

Providing structural support and housing for the rail guides 420 and 421 and rail side covers 425 and 426 in the support stand 401 are vertical supports 441, lateral supports 442 and side support bars 443. In embodiments, two vertical supports 441 support each of the rail guides 420 and 421. Each vertical support 441 is welded to the outside of a rail guide and a rail side cover. In embodiments, two lateral supports 442 provide lateral support for the support stand 401 and are welded to the vertical supports 441. Optionally, each lateral support 442 has a lateral support end cap 445 at one end.

The support stand 401 can be mounted to a side wall by four side support bars 443 welded to and extending from one side of the support stand 401. These side support bars 443 provide support against a side wall. One of the side support bars 443 can not be seen in FIG. 4. Depending on the location of the Postal-Go-Round 400, the side wall can be outdoors, such as an exterior building wall, inside a building, or inside a vehicle. At the ends of side support bars 443 are attached side wall mounts 444, and the side wall mounts 444 are attached to a wall with screws. The circumference of the side wall mounts 444 can be larger than the circumference of the side support bars 443. If the Postal-Go-Round 400 is placed in a standard mail van or truck, the side wall mounts must clear eleven inches, which is the height of a hump in the floor of the truck that accommodates the truck's back tires.

Attached to the bottom of vertical supports 441 are floor mounts 451, respectively. Resting on the floor, disks 451 stabilize the Postal-Go-Round 400, as the disks can be larger in circumference than vertical supports 441. Depending on the location of the Postal-Go-Round 400, the floor can be outdoors on the ground, the floor inside a building, or the floor inside a vehicle. Disks 451 can be used as mounts to the flooring with screws to stabilize the Postal-Go-Round 400 further.

In a vehicle with sufficient space to house Postal-Go-Round 400, the Postal-Go-Round can be attached to the left side or the right side of the vehicle, or two Postal-Go-Rounds can be located side by side. Postal-Go-Round 400 is thus customizable to attach to a vehicle interior either on the left wall or on the right wall.

FIG. 5 shows an alternative example bin carrier, according to embodiments of the present invention. For convenience, components carried over from FIG. 4 to FIG. 5 are similarly labeled. This bin carrier is the same as those bin carriers shown in FIG. 4. Bin carrier 501 has first and second L brackets 502 and 503 that are parallel to each other. The L brackets 502 and 503 provide vertical support for a storage bin (not shown). Upper and lower rectangles 504 and 505 are parallel to each other and provide support for the four sides of a storage bin (not shown). The rectangles 504 and 505 are both attached to L brackets 502 and 503. Angled portions 506 and 507 extend from the L brackets 502 and 503, respectively, at approximately forty-five degrees toward the center of the bin carrier. At the ends of angled portions 506 and 507 are circular carrier mounts 411 and 412 through which the bin support bars 410 are placed. The bin support bars 410 can rotate within the circular portions 508 and 509. A square U-shaped part 510 provides further support for a storage bin.

A user can hold both sides of a typical storage bin (not shown) using bin handles formed by the top of the storage bin and cut-out areas near the top of the storage bin. The user places the storage bin into the bin carrier 501 in this example at a slight angle, and the storage bin drops into place in the bin carrier. The user can unload the storage bin by gripping the bin handles and pulling the storage bin out of bin carrier 501 at a slight angle. The user can use the front side 511 of upper rectangle 504 on the bin carrier for leverage in pulling the storage bin out of the holder.

For both embodiments shown in FIGS. 1 and 4, the Postal-Go-Round is designed to be both light-weight and strong. The Postal-Go-Round is light-weight to make it more easily portable, as well as to reduce the load in a vehicle. In some embodiments, the following elements of Postal-Go-Round 100 are made from light-weight aluminum: support stands 101 and 401; bin carriers 102, 103, and 406; and bin support bars 410. In embodiments, the Postal-Go-Round 100 can be made of any type of metal. Preferably, Postal-Go-Round 100 is made to weigh no more than one hundred pounds. The Postal-Go-Round is strong in order to carry heavy freighting goods. In some embodiments, the Postal-Go-Round 100 can hold up to one thousand pounds total in the bin carriers.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps performed in the embodiments of the invention disclosed can be performed in alternate orders, certain steps can be omitted, and additional steps can be added. It is to be understood that other embodiments of the invention can be developed and fall within the spirit and scope of the invention and claims. The embodiments were chosen and described in order to best explain the principles of the invention and its practical application, thereby enabling others of ordinary skill in the relevant arts to understand the invention for various embodiments and with various modifications that are suited to the particular use contemplated. It is intended that the scope of the invention be defined by the following claims and their equivalents.

What is claimed is:

1. An apparatus for assisting a user in loading and unloading storage bins and goods to and from the back of a vehicle; the apparatus comprising:
two chain drive supports that are elliptical in shape and positioned vertically and parallel to each other;
two chain drives that rotate around a plurality of sprocket guides attached to the two chain drive supports, the chain drives positioned on the inside of the chain drive supports such that the chain drives face each other;
a plurality of bin carriers attached on two sides to the two chain drives, each bin carrier capable of receiving a storage bin;
a support stand that supports the chain drive supports and attaches to the vehicle floor via floor mounts; and
a motor attached to the support stand that drives a plurality of parallel chain drives, which in turn drive the two chain drives in unison to cause the bin carriers to rotate around each other in an ellipsis.

2. The apparatus of claim 1, wherein each bin carrier comprises a front part attached to a lower hinge of the bin carrier, such that the front part latches and unlatches to the sides of the bin carrier to allow a user to load and unload a storage bin.

3. The apparatus of claim 1, wherein the two sides of the bin carrier comprise bin carrier handles that are each attached to a carrier mount that is in turn attached to one of the two chain drives.

4. The apparatus of claim 1, further comprising a switch including buttons that enable the user to turn the motor on and off, and to move the two chain drives clockwise and counterclockwise.

5. The apparatus of claim 1, wherein two chain guards attached to the chain drive supports protect the user from touching the chain drives.

6. The apparatus of claim 1, wherein the motor that drives a plurality of parallel chain drives further comprises:
a motor drive chain attached to the motor;
a first double sprocket assembly and a sprocket guide, each attached to the support stand;
a motor sprocket guide driven by the motor, such that the motor sprocket guide drives the motor drive chain around the first double sprocket assembly;
a horizontal shaft connected to both the first double sprocket assembly and the sprocket guide in order to rotate the sprocket guide in unison with the first double sprocket assembly;
second and third double sprocket assemblies, each attached to one of the two chain drive supports, the second and third double sprocket assemblies each drive one of the two chain drives; and
two parallel chain drives driven by the first double sprocket assembly and the sprocket guide, the two parallel chain drives each drives one of the two chain drives via the second and third double sprocket assemblies.

7. The apparatus of claim 1, wherein belts are used instead of chain drives, and rail guides that are elliptical in shape are used instead of chain drive supports and sprocket guides, such that belts rotate directly around the rail guides.

8. The apparatus of claim 7, wherein each bin carrier comprises two carrier mounts that rotate around a bin support bar, such that the bin support bar is attached to both of the belts.

9. The apparatus of claim 1, further comprising a plurality of side support bars that extend from one side of the support stand to mount the support stand to a wall of the vehicle instead of floor mounts to mount the support stand to the floor of the vehicle.

10. A method for assisting a user in loading and unloading storage bins and goods to and from the back of a vehicle; the method comprising:
providing two chain drive supports that are elliptical in shape and positioned vertically and parallel to each other;
attaching a plurality of sprocket guides to the two chain drive supports to allow two chain drives to rotate around the plurality of sprocket guides, the chain drives positioned on the inside of the chain drive supports such that the chain drives face each other;
attaching a plurality of bin carriers on two sides to the two chain drives, each bin carrier capable of receiving a storage bin;
providing a support stand that supports the chain drive supports and attaches to the vehicle floor via floor mounts; and
rotating the two chain drives in unison by attaching them to a motor, the motor attached to the support stand and driving a plurality of parallel chain drives, which in turn drive the two chain drives to cause the bin carriers to rotate around each other in an ellipsis.

11. The method of claim 10, further comprising latching and unlatching of a front part of each bin carrier to the sides of the bin carrier to allow a user to load and unload a storage bin, the front part attached to a lower hinge of the bin carrier.

12. The method of claim 10, wherein attaching a plurality of bin carriers on two sides comprises for each bin carrier attaching each of two bin carrier handles of the bin carrier to a carrier mount, and each carrier mount is attached to one of the two chain drives.

13. The method of claim 10, further comprising providing a switch including buttons that enable the user to turn the motor on and off, and to move the two chain drives clockwise and counterclockwise.

14. The method of claim 10, further comprising protecting the user from touching the chain drives by two chain guards attached to the chain drive supports.

15. The method of claim 10, wherein rotating the two chain drives by the motor that drives a plurality of parallel chain drives further comprises:
attaching a motor drive chain to the motor;
attaching both a first double sprocket assembly and a sprocket guide to the support stand;
providing a motor sprocket guide driven by the motor, the motor sprocket guide driving the motor drive chain around the first double sprocket assembly;
connecting a horizontal shaft to both the first double sprocket assembly and the sprocket guide in order to rotate the sprocket guide in unison with the first double sprocket assembly;
attaching second and third double sprocket assemblies to the two chain drive supports, such that each of the second and third double sprocket assemblies is attached to one of the two chain drive supports, the second and third double sprocket assemblies each driving one of the two chain drives; and
driving two parallel chain drives by the first double sprocket assembly and the sprocket guide, the two parallel chain drives each driving one of the two chain drives via the second and third double sprocket assemblies.

16. The method of claim 10, further comprising providing belts instead of chain drives, and providing rail guides that are elliptical in shape instead of chain drive supports and sprocket guides, such that belts rotate directly around the rail guides.

17. The method of claim 16, further comprising providing a bin support bar and two carrier mounts for each bin carrier, such that the bin support bar is attached to both of the belts and the bin carrier mounts of the bin carrier rotate around a bin support bar.

18. The method of claim 10, further comprising mounting the support stand to a wall instead of to a floor of the vehicle via a plurality of side support bars that extend from one side of the support stand and mount to the wall of the vehicle.

19. A machine-readable medium, including operations stored thereon that, when processed by one or more processors, causes a system to perform the steps of:
providing two chain drive supports that are elliptical in shape and positioned vertically and parallel to each other;
attaching a plurality of sprocket guides to the two chain drive supports to allow two chain drives to rotate around the plurality of sprocket guides, the chain drives positioned on the inside of the chain drive supports such that the chain drives face each other;
attaching a plurality of bin carriers on two sides to the two chain drives, each bin carrier capable of receiving a storage bin;
providing a support stand that supports the chain drive supports and attaches to the vehicle floor via floor mounts; and
mechanizing the two chain drives in unison by attaching a motor to the support stand, the motor driving a plurality of parallel chain drives, which in turn drive the two chain drives to cause the bin carriers to rotate around each other in an ellipsis.
